(19) United States
(12) Patent Application Publication
(10) Pub. No.: US 2026/0028242 A1
(43) Pub. Date: Jan. 29, 2026

(54) PROCESS FOR MAKING AN (OXY)HYDROXIDE, AND (OXY)HYDROXIDE

(71) Applicant: BASF SE, Ludwigshafen Am Rhein (DE)

(72) Inventors: Joop Enno FRERICHS, Ludwigshafen am Rhein (DE); Thorsten BEIERLING, Ludwigshafen am Rhein (DE); Maike WIRTZ, Ludwigshafen am Rhein (DE); Rafael Benjamin BERK, Ludwigshafen am Rhein (DE)

(21) Appl. No.: 18/994,126

(22) PCT Filed: Aug. 7, 2023
(86) PCT No.: PCT/EP2023/071822

§ 371 Date: Jan. 14, 2025

(30) Foreign Application Priority Data
Aug. 15, 2022 (EP) 22190430.3

(51) Int. Cl. C01G 53/05; C01G 53/50; H01M 4/505; H01M 4/525

(52) U.S. Cl. CPC C01G 53/05; C01G 53/50; H01M 4/505; H01M 4/525; C01P 2002/50; C01P 2002/72; C01P 2004/03; C01P 2004/50; C01P 2004/61; C01P 2006/12; C01P 2006/40

(57) ABSTRACT

Disclosed herein is a process for making an (oxy)hydroxide of TM where TM refers to metals of which at least 97 mol-% are transition metals and where TM includes manganese and nickel, and where at least 50 mol-% of TM are manganese, the process including the steps of:
(a) providing at least one aqueous solution (α) of water-soluble salts of such metals and an aqueous solution (β) including alkali metal hydroxide selected from the group consisting of NaOH and KOH,
(b) combining solutions (α) and (β) at a pH value in the range of from 9.5 to 10.3, where such step (b) is carried out using at least one coaxial mixer including two coaxially orientated pipes through which an aqueous solution (β) and an aqueous solution of (α) are introduced into a stirred vessel, thereby precipitating an (oxy)hydroxide of TM, and
(c) recovering and drying the (oxy)hydroxide of TM.

The present invention is directed towards a process for making an (oxy)hydroxide of TM wherein TM refers to metals of which at least 97 mol-% are transition metals and wherein TM comprises manganese and nickel, and wherein at least 50 mol-% of TM are manganese, said process comprising the steps of
(a) providing at least one aqueous solution (α) of water-soluble salts of such metals and an aqueous solution (β) comprising alkali metal hydroxide selected from NaOH and KOH,
(b) combining solutions (α) and (β) at a pH value in the range of from 9.5 to 10.3, wherein such step (b) is carried out using at least one coaxial mixer comprising two coaxially orientated pipes through which an aqueous solution (β) and an aqueous solution of (α) are introduced into a stirred vessel, thereby precipitating an (oxy)hydroxide of TM,
(c) recovering and drying said (oxy)hydroxide of TM.

Lithiated transition metal oxides are currently used as electrode active materials for lithium-ion batteries. Extensive research and developmental work have been performed in the past years to improve properties like charge density, specific energy, but also other properties like the reduced cycle life and capacity loss that may adversely affect the lifetime or applicability of a lithium-ion battery. Additional effort has been made to improve manufacturing methods.

Many electrode active materials discussed today are of the type of lithiated nickel-cobalt-manganese oxide (“NCM materials”) or lithiated nickel-cobalt-aluminum oxide (“NCA materials”).

In a typical process for making cathode materials for lithium-ion batteries, first a so-called precursor is being formed by co-precipitating the transition metals as carbonates, oxides or preferably as (oxy)hydroxides. The precursor is then mixed with a lithium compound such as, but not limited to LiOH, Li₂O or Li₂CO₃ and calcined (fired) at high temperatures. Lithium compound(s) can be employed as hydrate(s) or in dehydrated form. The calcination—or firing—generally also referred to as thermal treatment or heat treatment of the precursor—is usually carried out at temperatures in the range of from 600 to 1,000° C. In cases hydroxides or carbonates are used as precursors a removal of water or carbon dioxide occurs first and is followed by the lithiation reaction. The thermal treatment is performed in the heating zone of an oven or kiln.

Extensive research has been performed on improvement of various properties of cathode active materials, such as energy density, charge-discharge performance such as capacity fading, and the like. However, many cathode active materials suffer from limited cycle life and voltage fade. This applies particularly to many Mn-rich cathode active materials.

In EP 3 486 980, specific high-manganese materials with a high energy density retention rate are disclosed. However, the cathode active materials disclosed suffer from a limited energy density as such.

It has been observed, though, that high-manganese materials suffer from a poor volumetric energy density.

It was therefore an objective of the present invention to provide electrochemical cells with high volumetric energy density. It was further an objective to provide a process for making electrode active materials for electrochemical cells with high volumetric energy density.

It has been found that the volumetric energy density may be improved by spherical particles due to their enhanced packing properties compared to irregular shaped particles.

It was found that the precursor of cathode active materials plays an important role, and, accordingly, the process for making (oxy)hydroxides as defined above was found, hereinafter also referred to as “inventive process” and “process according to the (present) invention”. The inventive process comprises the steps (a) and (b) and (c), hereinafter also referred to as step (a) or simply as (a), and as step (b) or briefly as (b), or step (c) or simply as (c). Steps (a) to (c) will be described in more detail below.

The inventive process is a process for precipitating an (oxy)hydroxide of TM wherein TM refers to metals of which at least 97 mol-% are transition metals and wherein TM comprises manganese and nickel, and wherein at least 50 mol-% of TM are manganese, preferably 60 to 85 mol-%. TM may comprise non-transition metals, for example aluminum or magnesium. More preferably, TM is a combination of manganese and nickel.

Said (oxy)hydroxide may be a stoichiometrically pure hydroxide or a hydroxide with anions other than hydroxide, for example carbonate or oxide. In the presence of oxidants, especially manganese is oxidized easily. Carbonate may especially be generated by adsorption of carbon dioxide, for example by alkali metal hydroxide or its aqueous solution.

In one embodiment of the present invention, TM corresponds to general formula (I)

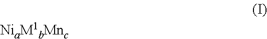

where the variables are each defined as follows:
M¹ is least one metal selected from Co, Ti, Zr, Nb, Ta, W, Sb, Sr, Al and Mg,
a is a number in the range from 0.20 to 0.50, preferably from 0.30 to 0.40,
b is a number in the range from zero to 0.05, preferably zero or 0.02 to 0.04,
c is a number in the range from 0.50 to 0.80, preferably 0.60 to 0.70,
and a+b+c=1.0.

In one embodiment of the present invention, TM contains only Mn and Ni.

TM may contain traces of further metal ions, for example traces of ubiquitous metals such as sodium, calcium or zinc, as impurities but such traces will not be taken into account in the description of the present invention. Traces in this context will mean amounts of 0.05 mol-% or less, referring to the total metal content of TM.

In one embodiment of the present invention, the resultant (oxy)hydroxide of TM is in particulate form, and with a monomodal particle diameter distribution. The particles size distribution may be determined by light scattering or LASER diffraction or electroacoustic spectroscopy, LASER diffraction being preferred. The average particle diameter (D50) is preferably in the range of from 2 to 15 μm, for example from 2 to 12 μm, and in preferred embodiments the average particle diameter D50 is in the range of from 3 to 8 μm.

In step (a), at least one aqueous solution (α) of water-soluble salts of such metals and an aqueous solution (β) comprising alkali metal hydroxide selected from NaOH and KOH is provided. It is possible to provide two or mor aqueous solutions (α), each of them containing one water-soluble salt. However, it is preferred to provide only one solution (α).

The term water-soluble salts of nickel or manganese or of metals other than nickel and manganese refers to salts that exhibit a solubility in distilled water at 25° C. of 25 g/l or more, the amount of salt being determined under omission of crystal water and of water stemming from aquo complexes. Water-soluble salts of nickel and manganese may preferably be the respective water-soluble salts of Ni²⁺ and Mn²⁺. Examples of water-soluble salts of nickel and manganese are the sulfates, the nitrates, the acetates and the halides, especially chlorides. Preferred are nitrates and sulfates, of which the sulfates are more preferred.

Said aqueous solution (α) preferably contains Ni and Mn and, optionally, further metal(s) in the relative concentration that is intended as TM of the precursor.

Solution(s) (α) may have a pH value in the range of from 2 to 5. In embodiments wherein higher pH values are desired, ammonia may be added to solution (α). However, it is preferred to not add ammonia to solution (α).

In one embodiment of the present invention, one solution (α) is provided that contains all the metals to be precipitated.

In step (a), in addition an aqueous solution of alkali metal hydroxide is provided, hereinafter also referred to as solution (β). An example of alkali metal hydroxides is lithium hydroxide, preferred is potassium hydroxide and a combination of sodium and potassium hydroxide, and even more preferred is sodium hydroxide.

Solution (β) may contain some amount of carbonate, e.g., 0.1 to 2% by weight, referring to the respective amount of alkali metal hydroxide, added deliberately or by aging of the solution or the respective alkali metal hydroxide.

Solution (β) may have a concentration of hydroxide in the range from 0.1 to 12 mol/l, preferably 6 to 10 mol/l.

The pH value of solution (β) is preferably 13 or higher, for example 14.5.

In the inventive process, it is preferred to use ammonia but to feed it separately as solution (γ) or in solution (β) but not in solution (α).

Optionally, at least one complexing agent selected from ammonia, glycine, citrate and oxalate may be provided. Glycine, citrate and oxalate are preferably provided as sodium salts. Said complexing agent may be contained in aqueous solution (β) or in separate aqueous solution (γ).

It is more preferred, though, to perform the inventive process without the use of a complexing agent.

Aqueous solution (γ) may contain in the range of from 1 to 25% by weight of ammonia.

Aqueous solution (γ) may contain in the range of from 0.1 to 5% by weight of glycine, citrate or oxalate as salts, for example as sodium salt. The percentage in each of these cases refers to the free acid.

In step (b) of the inventive process, aqueous solutions (α) and (β) are combined at a pH value in the range of from 9.5 to 10.3, preferably 9.5 to 10.0, wherein step (b) is carried out using at least one coaxial mixer comprising two coaxially orientated pipes through which an aqueous solution (β) and an aqueous solution (α) are introduced into a stirred vessel. The pH value refers to a determination at 23° C.

During step (b), care is taken that a minimum pH value of 9.5 is achieved. Additionally, during step (b) care is taken that a pH value of 10.3 is not exceeded. Preferably, the pH value is kept at constant a certain value in the range of 10.0 to 10.3, +0.01.

In the context of the present invention, a coaxial mixer comprises two coaxially arranged pipes through which aqueous solution (β) and aqueous solution (α) are introduced into a stirred vessel. In one embodiment of the present invention, the introduction step is carried out by using two or more coaxial mixers through which aqueous solution (β) and aqueous solution (α) are introduced into said stirred vessel. In another embodiment of the present invention, the introduction step is carried out by using exactly one system of coaxially arranged pipes through which aqueous solution (β) and aqueous solution (α) are introduced into said stirred vessel.

In a preferred embodiment of the present invention, the aqueous solution (α) is introduced through the inner pipe of a coaxial mixer and the aqueous solution (β) is introduced through the outer pipe, this will lead to a minor degree of incrustations.

In one embodiment of the present invention, the inner pipe of said coaxial mixer has an inner diameter in the range of from 1 mm to 120 mm, preferred in the range from 5 mm to 50 mm, depending on the vessel size. The bigger the vessel, the bigger the diameter of the inlet tip.

In one embodiment of the present invention, the outer pipe of such coaxial mixer has an inner diameter in the range of from 1.5 to 10 times the inner diameter of the inner pipe, preferred 1.5 to 6 times.

Said pipes preferably have a circular profile.

In one embodiment of the present invention, the walls of the pipes have a thickness in the range of from 1 to 10 mm.

Said pipes may be made from steel, stainless steel, or from steel coated with PTFE (polytetrafluoroethylene), FEP (fluorinated ethylene-propylene copolymer), or PFA (perfluoroalkoxy polymer), preference being given to stainless steel.

In one embodiment of the present invention, the pipes of the coaxial mixer are bent. In a preferred embodiment of the present invention, the pipes of the coaxial mixer are non-bent.

Said coaxial mixer may serve as coaxial nozzle.

In one embodiment of the present invention locations of the introduction of the aqueous solutions (α) and (β) are above the level of liquid, for example by 3 to 50 cm. In a preferred embodiment of the present invention, the locations of the introduction of the aqueous solutions of transition metal salts and of alkali metal hydroxide are below the level of liquid, for example by 5 to 250 cm, preferably larger than 10 cm up to 200 cm.

If aqueous solution (γ) is introduced as well, such aqueous solution (γ) is preferably introduced through the coaxial mixer as well.

In one embodiment of the present invention, step (b) is performed at a temperature in the range of from 5 to 75° C., preferably 35 to 70° C.

Pressure conditions for step (b) are generally not critical. Step (b) may be performed at ambient pressure or at a slightly elevated pressure, for example at a pressure that is in the range of from 5 mbar to 5 bar higher than ambient pressure.

In one embodiment of the present invention, the residence time of step (b) is in the range of from 10 minutes to 12 hours.

Step (b) may be carried continuously or as a batch process. In one embodiment, step (b) is performed as a batch process, and mother liquor is removed (withdrawn) through a solid-liquid separation device, for example a clarifier such as a lamellar clarifier.

In one embodiment of the present invention, the vessel is a continuous stirred tank reactor. Said continuous stirred tank reactor is advantageously equipped with a device to control the temperature, and with devices such as baffles, guide vanes, or the like.

Step (b) is preferably performed in the absence of oxidants like oxygen. For that purpose, step (b) may be performed under inert atmosphere, for example nitrogen or a noble gas such as argon.

Preferably, step (b) is performed under mixing, for example stirring. In one embodiment, a stirring energy input in the range of from 2.0 to 25.0 W/l is introduced.

In the course of step (b), a slurry of (oxy)hydroxide of TM is formed. To increase the capacity of the stirred reactor, mother liquor may be removed during step (b), for example through a clarifier. Mother liquor in this context refers to water that contains, e.g., the respective alkali metal salt of the counter ion of TM, complexing agent if applicable, and traces of alkali metal hydroxide.

After having performed step (b), a step (c) is performed,
(c) recovering and drying said (oxy)hydroxide of TM.

Step (c) preferably includes a solid-liquid separation step, for example with a centrifuge or by filtration, e.g., with a belt filter or a filter press. By said solid-liquid separation step, the liquid phase (“mother liquor”) is removed, and a particulate hydroxide is recovered.

A filtration step preferably includes one or more washing steps. The filter cake may be washed with water or with an aqueous solution of NaOH or KOH, for example a diluted solution (β). A solid residue is obtained and mother liquor, for example a filtrate.

After having recovered said (ox) hydroxide of TM, the resultant solid residue may be dried, for example at a temperature in the range of from 80 to 120° C. Said drying may be performed in vacuo, under inert gas such as nitrogen, or in air. In embodiments wherein the residue is dried under air, an at least partial oxidation of the manganese may occur, and part of the hydroxide may be converted to oxide. Preferably, the majority of the manganese is converted into the oxidation state of +IV.

In one embodiment of the present invention, after step (b) a sub-step (b+) is performed, transferring slurry from step (b) to a second stirred vessel in which it is combined with solutions (α) and (β) at a pH value in the range of from 9.5 to 11.0 measured at 23° C., wherein step (b+) is carried out in a continuous or batch or semi-continuous process, thereby further growing particles of (oxy)hydroxide of TM.

Temperature conditions and general definitions of solutions (α) and (β) are as above in step (b).

In one embodiment of the present invention, step (b+) has a duration in the range of from 1 to 10 hours.

A particulate hydroxide is obtained that is an excellent precursor for a cathode active material. Said precursor may be mixed with a compound of lithium, e.g., with LiOH or Li₂CO₃ or Li₂O₂, and, optionally, with one or more additives such as Al₂O₃, TiO₂, ZrO₂, Zr(OH)₄ or oxyhydroxides of Al, Ti or Zr, and then thermally treated at a temperature in the range of from 800 to 1000° C. The molar ratio Li:TM is preferably in the range of from 1.05:1 to 1.5:1, preferably 1.25 to 1.4.

Another aspect of the present invention is directed towards precursors for cathode active materials for lithium-ion batteries. Said precursors are hereinafter also referred to as inventive precursors or inventive (oxy)hydroxides. Inventive precursors are in the form of particulate (oxy) hydroxides of TM wherein TM refers to metals of which at least 97 mol-% are transition metals and wherein TM comprises manganese and nickel, and wherein at least 50 mol-% of TM are manganese,

$$0 \leq x < 1 , 1 < y \leq 2 , and 0 \leq t \leq 0.1 ,$$

wherein said particulate transition metal (oxy)hydroxide has an average secondary particle diameter D50 in the range of from 2 to 15, preferably from 3 to 8 μm,
and wherein such secondary particles are agglomerated from primary particles that are essentially radially oriented.

“Essentially radially oriented” does not require a perfect radial orientation but includes that in an SEM analysis, a deviation to a perfectly radial orientation is at most 5 degrees.

Furthermore, at least 60% of the secondary particle volume is filled with radially oriented primary particles. Preferably, only a minor inner part, for example at most 40%, preferably at most 20%, of the volume of those particles is filled with non-radially oriented primary particles, for example, in random orientation.

Preferably, inventive precursors display reflections at 8.6 to 9.0 (a), 16.00 to 18.00 (b) and 21.40 to 22.00° 2θ (c) in X-ray diffraction analyses recorded with Cu-Kα-radiation.

Preferred are particulate metal (oxy)hydroxide according to general formula (II)

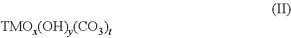

preferably, TM corresponds to formula (I)

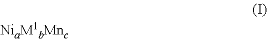

where the variables are each defined as follows:
M¹ is at least one metal selected from Co, Ti, Zr, Nb, Ta, W, Sb, Sr, Al and Mg,
a is a number in the range from 0.20 to 0.50, preferably from 0.30 to 0.40,
b is a number in the range from zero to 0.05, preferably zero or 0.02 to 0.04,
c is a number in the range from 0.50 to 0.80, preferably 0.60 to 0.70,
and a+b+c=1.0.

In one embodiment of the present invention, TM contains only Mn and Ni.

In one embodiment of the present invention, inventive (oxy)hydroxides have a specific surface according to BET in the range of from 2 to 50 m²/g, determined by nitrogen adsorption according to DIN-ISO 9277:2003-05, after outgassing at 120° C. for one hour.

In one embodiment of the present invention, the particle size distribution [(D90)−(D10)] divided by (D50) of inventive (oxy)hydroxides is in the range of from 0.3 to 2, preferably 0.5 to 1.0.

In one embodiment of the present invention the average form factor of secondary particles of inventive (oxy)hydroxides is higher than 0.80 when determined by Scanning Electron Microscopy (“SEM”) imaging in 1000× magnification, preferably at least 0.85. Upper limits are 1.0, or at least up to 0.98. For said imaging, a representative sample of 100 particles is analyzed. The form factor of individual particles was calculated from the perimeter and area determined from top view SEM images:

Form factor=(4π·area)/(perimeter)²

While, a perfect sphere would possess a form factor of 1.0, any deviation from perfect sphericity lead to form factors <1.0.

The average form factor is then determined by averaging at least 30, for example 30 to 40 particles.

A further aspect of the present invention is related to the use of inventive precursors for the manufacture of cathode active materials for lithium-ion batteries. A further aspect of the present invention is related to a process for making a cathode active material for a lithium-ion battery wherein said process includes the steps of
(1) mixing at least one inventive precursor with at least one compound of lithium selected from lithium hydroxide, lithium carbonate and lithium peroxide and, optionally, at least one oxide or (oxy)hydroxide or sulfate of Mg, Al, Ti, Zr, Nb, Ta, W or Mo, and
(2) heating the mixture obtained from step (1) to 800 to 1000° C., preferably 850 to 970° C.

Examples of suitable oxides oxide or (oxy)hydroxide or sulfate of Mg, Al, Ti, Zr, Nb, Ta, W or Mo are MgO, Mg(OH)₂, MgSO₄, AlOOH, Al(OH)₃, Al₂O₃, Al₂(SO₄)₃, TiO(OH)₂, TiO₂, TiOSO₄, Ti(OH)₄, TiO₂·aq, Zr(OH)₄, ZrO(OH)₂, ZrO₂, ZrOSO₄, ZrO₂·aq, Nb₂O₅, niobic acid, Ta₂O₅, WO₃, MoO₃, and combinations of at least two of the foregoing.

The stoichiometric ratio of lithium to TM is preferably in a way that it exceeds the metals from TM.

Heating at step (2) may be performed in a kiln, for example a rotary kiln, a roller hearth kiln or a pusher kiln.

The duration of step (2) may be in the range of from 3 to 24 hours, preferably 4 to 12 hours.

In one embodiment of the present invention, the temperature is ramped up before reaching the desired temperature of from 800 to 1000° C., preferably 850 to 970° C. For example, first the mixture of step (1) is heated to a temperature to 250 to 350° C. and then held constant for a time of 10 min to 4 hours, and then it is raised to 400 to 550° C. and held constant for a time of 10 min to 4 hours, and then it is increased to 800 to 1000° C., preferably 850 to 970° C.

In one embodiment of the present invention, the heating rate in step (2) is in the range of from 0.1 to 10° C./min.

In one embodiment of the present invention, after step (2) a post-treatment is performed, hereinafter referred to as step (3), for example with water, an aqueous solution of aluminum or magnesium or titanium sulfate or zirconium sulfate or sulfuric acid, or a combination of sulfuric acid and aluminum or titanium or magnesium sulfate. After such a treatment, it is preferred to perform another heat treatment step, for example at 300 to 600° C.

In one embodiment of the present invention, said treatment is carried out with a solution of a compound of Mg, Al, Ti or Zr in a mineral acid, for example a solution of Al₂(SO₄)₃ in aqueous H₂SO₄.

The treatment in step (3) may be performed by adding the mineral acid or the solution of a compound of Mg, Al, Ti or Zr to the cathode active material of step (2) and allowing the resultant mixture to interact. Such interaction may be enhanced by stirring.

In one embodiment of the present invention, step (3) is performed at a temperature in the range of from 5 to 85° C., preferred are 10 to 60° C. Ambient temperature is particularly preferred.

In one embodiment of the present invention, step (3) is performed at normal pressure. It is preferred, though, to perform step (3) under elevated pressure, for example at 10 mbar to 10 bar above normal pressure, or with suction, for example 50 to 250 mbar below normal pressure, preferably 100 to 200 mbar below normal pressure.

In one embodiment of the present invention, step (3) is performed in a filter device with stirrer, for example a pressure filter with stirrer or a suction filter with stirrer.

The duration of treatment of the material obtained from step (2) with compound of Mg, Nb, W, Al, Ti or Zr may be in the range of from 2 to 60 minutes, preferred are 10 to 45 minutes.

In one embodiment of the present invention, the volume ratio of material obtained from step (2) to mineral acid or solution of compound of Mg, Nb, W, Al, Ti or Zr, respectively, is in the range of from 1:1 to 1:10, preferably 1:1 to 1:5.

In one embodiment of the present invention, step (3) is repeated, for example once to 10 times. In preferred embodiments, step (3) is performed only once.

A further aspect of the present invention is related to cathode active material, hereinafter also referred to as inventive cathode active materials. Inventive cathode active materials are particulate materials according to the general formula Li₁₊ₖTM₁₋ₖO₂ wherein k is in the range of from 0.1 to 0.3, and wherein TM refers to a combination of metals of which at least 97 mol-% are transition metals and wherein TM comprises manganese and nickel, and wherein at least 50 mol-% of TM are manganese,
wherein said particulate cathode active material has an average secondary particle diameter D50 in the range of from 2 to 15 μm, preferably 3 to 8 μm,
and wherein such secondary particles are agglomerated from primary particles that are essentially radially oriented, and wherein the secondary particles have an average form factor of that is higher than 0.80 when determined by SEM imaging in 1000× magnification, preferably at least 0.85.

“Essentially radially oriented” does not require a perfect radial orientation but includes that in an SEM analysis, a deviation to a perfectly radial orientation is at most 5 degrees.

Furthermore, at least 60% of the secondary particle volume is filled with radially oriented primary particles. Preferably, only a minor inner part, for example at most 40%, preferably at most 20%, of the volume of those particles is filled with non-radially oriented primary particles, for example, in random orientation.

In one embodiment of the present invention, TM corresponds to general formula (I)

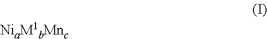

where the variables are each defined as follows:
M¹ is least one metal selected from Co, Ti, Zr, Nb, Ta, W, Sb, Sr, Al and Mg,
a is a number in the range from 0.20 to 0.50, preferably from 0.30 to 0.40,
b is a number in the range from zero to 0.05, preferably zero or 0.02 to 0.04,
c is a number in the range from 0.50 to 0.80, preferably 0.60 to 0.70,
and a+b+c=1.0.

In one embodiment of the present invention, TM contains only Mn and Ni.

In one embodiment of the present invention, inventive cathode active material comprises secondary particles that comprise primary particles to the general formula Li₁₊ₖTM₁₋ₖO₂ that are coated with at least one oxide compound of Nb, W, Ti or Zr, preferably Nb, Ti or Zr.

A further aspect of the present invention refers to electrodes comprising at least one electrode active material according to the present invention. They are particularly useful for lithium-ion batteries. Lithium-ion batteries comprising at least one electrode according to the present invention exhibit a good discharge behavior. Electrodes comprising at least one electrode active material according to the present invention are hereinafter also referred to as inventive cathodes or cathodes according to the present invention.

Specifically, inventive cathodes contain
(A) at least one inventive cathode active material,
(B) carbon in electrically conductive form,
(C) a binder polymer, also referred to as binder or binder (C), and, preferably,
(D) a current collector.

In a preferred embodiment, inventive cathodes contain
(A) 80 to 98% by weight inventive cathode active material,
(B) 1 to 17% by weight of carbon,
(C) 1 to 15% by weight of binder polymer,
   percentages referring to the sum of (A), (B) and (C).

Cathodes according to the present invention can comprise further components. They can comprise a current collector, such as, but not limited to, an aluminum foil. They can further comprise conductive carbon and a binder.

Cathodes according to the present invention contain carbon in electrically conductive modification, in brief also referred to as carbon (B). Carbon (B) can be selected from soot, active carbon, carbon nanotubes, graphene, and graphite, and from combinations of at least two of the foregoing.

Suitable binders (C) are preferably selected from organic (co)polymers. Suitable (co)polymers, i.e., homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol-% of copolymerized ethylene and up to 50 mol-% of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol-% of copolymerized propylene and up to 50 mol-% of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder (C) is polybutadiene.

Other suitable binders (C) are selected from polyethylene oxide (PEO), cellulose, carboxymethylcellulose, polyimides and polyvinyl alcohol.

In one embodiment of the present invention, binder (C) is selected from those (co)polymers which have an average molecular weight Mw in the range from 50,000 to 1,000,000 g/mol, preferably to 500,000 g/mol.

Binder (C) may be selected from cross-linked or non-cross-linked (co)polymers.

In a particularly preferred embodiment of the present invention, binder (C) is selected from halogenated (co)polymers, especially from fluorinated (co)polymers. Halogenated or fluorinated (co)polymers are understood to mean those (co)polymers which comprise at least one (co) polymerized (co) monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders (C) are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

Inventive cathodes may comprise 1 to 15% by weight of binder(s), referring to electrode active material. In other embodiments, inventive cathodes may comprise 0.1 up to less than 1% by weight of binder(s).

A further aspect of the present invention is a battery, containing at least one cathode comprising inventive electrode active material, carbon, and binder, at least one anode, and at least one electrolyte.

Embodiments of inventive cathodes have been described above in detail.

Said anode may contain at least one anode active material, such as carbon (graphite), TiO₂, lithium titanium oxide, silicon or tin. Said anode may additionally contain a current collector, for example a metal foil such as a copper foil.

Said electrolyte may comprise at least one non-aqueous solvent, at least one electrolyte salt and, optionally, additives.

Non-aqueous solvents for electrolytes can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20 mol-% of one or more C₁-C₄-alkylene glycols. Polyalkylene glycols are preferably polyalkylene glycols having two methyl or ethyl end caps.

The molecular weight Mw of suitable polyalkylene glycols and in particular suitable polyethylene glycols can be at least 400 g/mol.

The molecular weight Mw of suitable polyalkylene glycols and in particular suitable polyethylene glycols can be up to 5000000 g/mol, preferably up to 2000000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and in particular 1,3-dioxolane.

Examples of suitable acyclic organic carbonates are dimethyl carbonate, ethyl methyl carbonate and diethyl carbonate.

Examples of suitable cyclic organic carbonates are compounds according to the general formulae (III) and (IV)

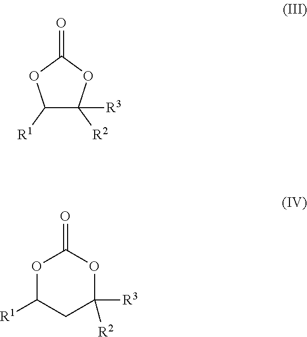

where R¹, R² and R³ can be identical or different and are selected from among hydrogen and C₁-C₄-alkyl, for example methyl, ethyl, n-propyl, isopropyl, n-butyl, isobutyl, sec-butyl and tert-butyl, with R² and R³ preferably not both being tert-butyl.

In particularly preferred embodiments, R¹ is methyl and R² and R³ are each hydrogen, or R¹, R² and R³ are each hydrogen. In another embodiment, R¹ is fluorine and R² and R³ are each hydrogen.

Another preferred cyclic organic carbonate is vinylene carbonate, formula (V).

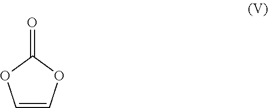

The solvent or solvents is/are preferably used in the water-free state, i.e., with a water content in the range from 1 ppm to 0.1% by weight, which can be determined, for example, by Karl-Fischer titration.

Electrolyte further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LIN(SO₂F)₂, LizSiF₆, LiSbF₆, LiAlCl₄ and salts of the general formula (CₙF₂ₙ₊₁SO₂)ₜYLi, where m is defined as follows:
t=1, when Y is selected from among oxygen and sulfur,
t=2, when Y is selected from among nitrogen and phosphorus, and
t=3, when Y is selected from among carbon and silicon.

Preferred electrolyte salts are selected from among LiC(CF₃SO₂)₃, LIN(CF₃SO₂)₂, LiPF₆, LiBF₄, LiClO₄, with particular preference being given to LiPF₆ and LiN(CF₃SO₂)₂.

In one embodiment of the present invention, batteries according to the invention comprise one or more separators by means of which the electrodes are mechanically separated. Suitable separators are polymer films, in particular porous polymer films, which are unreactive toward metallic lithium. Particularly suitable materials for separators are polyolefins, in particular film-forming porous polyethylene and film-forming porous polypropylene.

Separators composed of polyolefin, in particular polyethylene or polypropylene, can have a porosity in the range from 35 to 45%. Suitable pore diameters are, for example, in the range from 30 to 500 nm.

In another embodiment of the present invention, separators can be selected from among PET nonwovens filled with inorganic particles. Such separators can have porosities in the range from 40 to 55%. Suitable pore diameters are, for example, in the range from 80 to 750 nm.

Batteries according to the invention further comprise a housing which can have any shape, for example cuboidal or the shape of a cylindrical disk or a cylindrical can. In one variant, a metal foil configured as a pouch is used as housing.

Batteries according to the invention display a good discharge behavior, for example at low temperatures (zero ° C. or below, for example down to −10° C. or even less), a very good discharge and cycling behavior.

Batteries according to the invention can comprise two or more electrochemical cells that combined with one another, for example can be connected in series or connected in parallel. Connection in series is preferred. In batteries according to the present invention, at least one of the electrochemical cells contains at least one cathode according to the invention. Preferably, in electrochemical cells according to the present invention, the majority of the electrochemical cells contains a cathode according to the present invention. Even more preferably, in batteries according to the present invention all the electrochemical cells contain cathodes according to the present invention.

The present invention further provides for the use of batteries according to the invention in appliances, in particular in mobile appliances. Examples of mobile appliances are vehicles, for example automobiles, bicycles, aircrafts or water vehicles such as boats or ships. Other examples of mobile appliances are those which move manually, for example computers, especially laptops, telephones or electric hand tools, for example in the building sector, especially drills, battery-powered screwdrivers or battery-powered staplers.

The present invention is further illustrated by working examples.

### BRIEF DESCRIPTION OF THE FIGURES/DRAWINGS

FIG. 1 shows top view SEM images of the inventive precursors TM-OH.1 (a, b) and TM-OH.2 (c, d). The top view SEM images of the comparative precursor C-TM-OH.3 are shown in panel (e) and (f).

For determination of the particle diameters, a Mastersizer 3000 from Malvern Panalytical GmbH was used. The sample was filled into the device until a light obscuration between 4.0-14.0% was achieved. The respective volume-based particle size distribution (PSD) was determined by laser diffraction based on Mie's scattering theory. A refractive index of 1.33 for H₂O as dispersant was selected, while a refractive index of 2.19 of the solid phase was selected.

### I. Manufacture of Precursors, TM-OH

Manufacturing examples, general remarks:

During all precipitation experiments the stirred vessel had a constant nitrogen overflow. The pH values refer to measurements at 23° C.
Aqueous solution (α.1): NiSO₄ and MnSO₄ (molar ratio of 1:2) with a total TM concentration of 1.65 mol/kg
Aqueous solution (β.1): aqueous NaOH solution (25 wt %)

### I.1 Manufacture of Inventive Precursor TM-OH.1

The inventive precursor TM-OH.1 was made in a 2.4 L stirred vessel with a dosing unit comprising a coaxial mixer. In addition, the stirred vessel included an overflow system and a clarifier.

The stirrer consisted of a stirring shaft equipped with two four-bladed pitch blade turbines. The stirred vessel was charged with 2 L of deionized water and the temperature was set to 55° C. under constant stirring, energy uptake of (ε_{average}˜6.3 W/L).

Aqueous solutions (α.1) and (β.1) were introduced into the stirred vessel through the coaxial mixer. The formation of a slurry was observed. The overall volume flow of solutions (α.1) and (β.1) was adjusted result in an average residence time of 5 h. During the reaction the pH value was set to 10.0 and kept constant by a pH regulation circuit adjusting the volume flow of solution (B. 1). The precipitation reaction was carried out in a continuous mode with a mother liquor withdrawal of 35% (through the clarifier with respect to the total volume flow). Through the overflow, resultant slurry was collected. The collected slurry contained about 400 g/L of TM-OH.1. TM-OH.1 was collected by filtration, washing with solution (β.1) (1 kg of solution (β.1) per kg of solid TM-OH. 1) and deionized water. Then, TM-OH.1 was dried at 120° C. for 14 hours.

### I.2 Manufacture of Inventive Precursor TM-OH.2

Example I.1 was repeated with the exceptions that no mother liquor was withdrawn through the clarifier, and the stirring energy input was set to ˜5.4 W/L. The slurry withdrawn through the overflow system contained 120 g/l solids. TM-OH.2 was obtained.

### I.3 Manufacture of the Comparative Precursor C-TM-OH.3

The manufacture of C-TM-OH.3 was carried out a 30 L stirred vessel without a coaxial mixer. The stirrer consisted out of a stirring shaft equipped with two four-bladed pitch blade turbines. Aqueous solutions (α.1) and (β.1) were introduced into the stirred vessel through separate dosing pipes. The formation of a slurry was observed. The overall volume flows of solutions (α.1) and (β.1) were adjusted resulting in an average residence time of 12 h. The pH value was set to 11.5 and was kept constant by a pH regulation circuit adjusting the volume flow of the solution (β.1).

The slurry withdrawn through the overflow system contained 120 g/l solids. C-TM-OH.3 was collected by filtration, washing with solution (β.1) (1 kg solution (β.1) per kg of solid C-TM-OH.3.) and deionized water. Then, C-TM-OH.3 was dried at 120° C. for 14 hours.

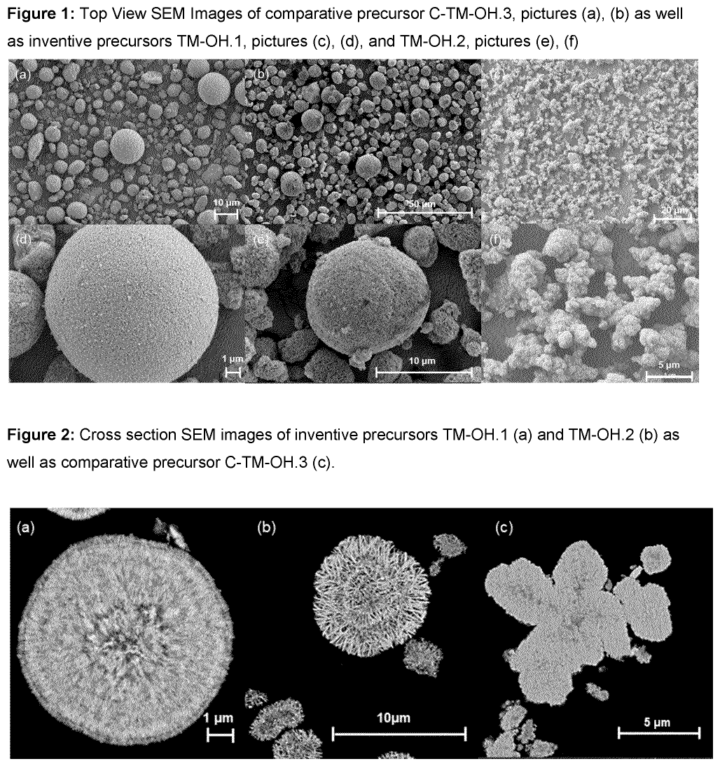

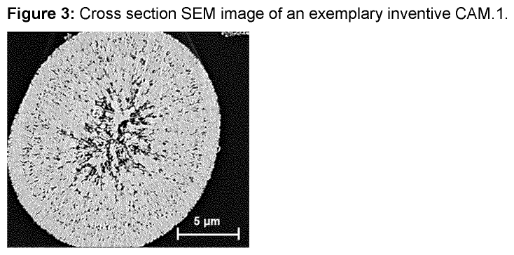

SEM images of the resulting precursors TM-OH.1, TM-OH.2 and C-TM-OH.3 are shown in FIG. 1 and additional cross-sections are shown in FIG. 2.

TABLE 1
Summary of the physical properties of the inventive and comparative precursors

| | | | BET | | | | | |
|---|---|---|---|---|---|---|---|---|
| | D50/ | | Surface/ | S content/ | Form | (I/I₀) | (I/I₀) | (I/I₀) |
| precursor | μm | span | m²/g | wt % | Factor | reflection a | reflection b | reflection c |
| TM-OH.1 | 6.7 | 1.57 | 31.0 | 0.24 | 0.82 | 1000 | 280 | 111 |
| TM-OH.2 | 6.0 | 1.38 | 33.3 | 0.34 | 0.86 | n.d. | n.d. | n.d. |
| C-TM-OH.3 | 5.7 | 1.33 | 22.4 | 0.06 | 0.74 | 1000 | 196 | 73 |

n.d.: not determined

II. Synthesis of Cathode Active Materials from the Inventive and Comparative Precursors
II.1 Synthesis of Cathode Active Materials CAM.1 and CAM.2 from the Inventive Precursors TM-OH.1 and TM-OH.2

The respective cathode active material was synthesized from inventive precursor TM-OH.1 or TM-OH.2 by mixing the dried precursor with Li₂CO₃ and each 0.1 mol-% Zr(OH)₄ and TiO₂, referring to the sum of Mn and Ni, in a molar ratio Li:(Ni+Mn+Ti+Zr) of 1.36:1. The resulting mixture was than filled into a crucible and heated up with 1.5° C./min to 950° C. and held at this temperature for 5 hours. Thereafter the obtained cathode active material (was cooled down to room temperature and was sieved using a 32 μm sieve before the posttreatment was applied. Calcined materials were obtained.

For the purpose of a posttreatment, the respective calcined material were treated with a mixture of aqueous H₂SO₄ and Al₂(SO₄)₃. 100 g of water, 200 g of 0.4 M H₂SO₄ and 37 μmol Al₂(SO₄)₃ were added to 100 g of the respective calcined material and stirred for 30 min. After filtration the CAM was washed with washing medium (water:calcined material 4:1), filtered and dried under vacuum. Finally, the so treated material was reannealed for 5 hours at 400° C. with a heating ramp of 3° C./min resulting in CAM.1 or CAM.2, respectively. A cross section SEM image of an CAM.1 is shown in FIG. 3.

II.2. Synthesis of the Comparative Cathode Material from the Comparative Precursor C-TM-OH.3

Comparative cathode active material C-CAM.3 was synthesized from the inventive precursors C-TM-OH.3 by mixing the dried precursor with Li₂CO₃, each 0.1 mol-% Zr(OH)₄ and TiO₂, referring to the sum of Mn and Ni, in a molar ratio Li:(Ni+Mn+Ti+Zr) of 1.36:1. The resulting mixture was than filled into a crucible and heated up with 1.5° C./min to 950° C. and held at this temperature for 6 h. Thereafter the obtained calcined material was cooled down to room temperature and was sieved using a 32 μm sieve before the posttreatment was applied.

For the purpose of a posttreatment the calcined material was treated with a mixture of aqueous H₂SO₄ and Al₂(SO₄)₃. 100 g of water, 200 g of 0.4M H₂SO₄ and 37 μmol Al₂(SO₄)₃ were added to 100 g of the comparative calcined material and stirred for 30 min. After filtration the CAM was washed with washing medium (water:calcined material=4:1), filtered and dried under vacuum. Finally, the so treated material was reannealed for 5 hours at 400° C. with a heating ramp of 3° C./min leading to the comparative cathode active material C-CAM.3.

TABLE 2
Summary of the physical properties of the resulting CAMs

| | d₅₀ | | BET Surface | Pressed | Form |
|---|---|---|---|---|---|
| CAM | [μm] | span | [m²/g] | density kg/l | factor |
| CAM.1 | 7.0 | 1.83 | 5.9 | 3.02 | 0.89 |
| CAM.2 | 5.8 | 1.80 | 6.1 | 2.82 | 0.81 |
| C-CAM.3 | 5.4 | 1.44 | 4.8 | 2.95 | n.d. |

The pressed density was determined at a pressure of 250 MPa

### III. Preparation of Electrodes, Electrolyte and Electrochemical Evaluation of the Inventive and Comparative Cathode Active Materials

### III.1 Electrode Preparation

Electrodes having the following composition: 94% cathode active material (CAM), 3% conductive agent (Super C65) and 3% the polymeric binder (polyvinylidene fluoride (PVDF), Solef 5130), were prepared by dissolving the binder in N-methyl-2-pyrrolidone and adding the conductive agent. The resulting slurry was dispersed in a planetary centrifugal mixer (ARE-250, Thinky Corp.; Japan), before the respective CAM was added and the resulting mixture was dispersed again using the same device as mentioned before to obtain a homogeneous slurry. Subsequently the slurry was cast onto aluminum foil using the doctor blade technique. After drying, circular electrodes circular electrodes with a diameter of 1.4 cm were punched out and dried at 120° C. under reduced pressure of 10-3 mbar for 12 hours. The mass loading was adjusted to equal 15 mg/cm².

### III.2 Electrolyte Manufacture

A base electrolyte composition containing 12.7 wt % of LiPF₆, 26.2 wt % of ethylene carbonate (EC), and 61.1 wt % of ethyl methyl carbonate (EMC) (EL base 1), based on the total weight of EL base 1 was prepared, before to this base electrolyte formulation 2 wt. % of vinylene carbonate (VC) was added resulting into the final composition EL base 2 used in the electrochemical evaluation of the electrodes based on the inventive and comparative CAMs.

### III.3 Cell Preparation and Electrochemical Evaluation

Coin-type half cells (20 mm in diameter and 3.2 mm in thickness) comprising a cathode prepared as described in III.1 as working electrode and lithium metal counter electrode, were assembled and sealed in an Ar-filled glove box. In addition, the cathode and anode and a separator were superposed in order of cathode//separator//Li foil to produce a half coin cell. Thereafter, 0.15 ml of the EL base 2 which is described above (III.2) were introduced into the coin cell. Electrochemical testing of the aforementioned coin cells was conducted on a Maccor 4000 battery cycler with 3.0 and 4.7 V (4.8 V in the activation cycle (first cycle) as lower and upper cut-off voltages, respectively. After the activation within the first cycles a C-rate test was employed to elucidate the rate capability of the CAM range from 0.2-3 C. After the C-rate test the electrodes were cycled with 0.5 C in the constant current constant voltage (CCCV) mode Table 3 gives a detailed summary of the different C-rates of the testing protocol.

TABLE 3
Overview of the used electrochemical evaluation protocol

| Cycle | C-rate charge/discharge^{a} | Mode |
|---|---|---|
| 1 | 0.067C | CCCV |
| 2 | 0.1C | CCCV |
| 4 | every 5% SOC | DCIR |
| 5 | 0.20, 0.5C | CCCV |
| 9 | 0.5C/1C | CCCV |
| 11 | 0.5C/2C | CCCV |
| 13 | 0.5C/3C | CCCV |
| 15 | 0.5C | CCCV |
| 17 | every 5% SOC | DCIR |
| 18 | 0.5C | CCCV |
| 69 | every 5% SOC | DCIR |
| 70 | 0.5C | CCCV |
| 121 | every 5% SOC | DCIR |

The stop criteria of constant voltage-step within the CCXCV mode was either a CV step for 1 h or a total current reaching 0.02 C

TABLE 4
Overview of the electrochemical performance of the inventive
CAMs CAM.1, CAM.2 and the comparative C-CAM.3.

| | Initial | | Rate Performance | | | Capacity & Retention | | |
|---|---|---|---|---|---|---|---|---|
| | DC/ | CE/ | 1 C/ | 2 C/ | 3 C/ | Q1/ | Q50/ | Q50/Q1/ |
| CAM | mAh g⁻¹ | % | mAh g⁻¹ | mAh g⁻¹ | mAh g⁻¹ | mAh g⁻¹ | mAh g⁻¹ | % |
| CAM.1 | 269.5 | 93.3 | 223.1 | 207.9 | 191.2 | 227.1 | 210.7 | 92.8 |
| CAM.2 | 266.9 | 92.6 | 215.9 | 201.4 | 188.7 | 218.7 | 204.8 | 93.6 |
| C-CAM.3 | 268.8 | 92.5 | 212.6 | 181.4 | 120.5 | 225.3 | 204.4 | 90.7 |

1. A process for making an (oxy)hydroxide of TM wherein TM refers to metals of which at least 97 mol-% are transition metals and wherein TM comprises manganese and nickel, and wherein at least 50 mol-% of TM are manganese, said process comprising the steps of:
(a) providing at least one aqueous solution (α) of water-soluble salts of such metals and an aqueous solution (β) comprising alkali metal hydroxide selected from the group consisting of NaOH and KOH,
(b) combining solutions (α) and (β) at a pH value in the range of from 9.5 to 10.3, wherein step (b) is carried out using at least one coaxial mixer comprising two coaxially orientated pipes through which an aqueous solution (β) and an aqueous solution of (α) are introduced into a stirred vessel, thereby precipitating an (oxy)hydroxide of TM, and
(c) recovering and drying said (oxy)hydroxide of TM.

2. The process according to claim 1, wherein the outlet of the pipes of the coaxial mixer is below the level of liquid.

3. The process according to claim 1, wherein aqueous solution (α) is introduced through the inner pipe of the mixer and aqueous solution β) is introduced through the outer pipe.

4. The process according to claim 1, wherein, between steps (b) and (c), a step (b+) is performed including the transfer of slurry from step (b) to a second stirred vessel in which it is combined with solutions (α) and (β) at a pH value in the range of from 9.5 to 11.0 measured at 23° C., wherein step (c) is carried out in a continuous or semi-continuous mode, thereby further growing the (oxy)hydroxides of TM.

5. The process according to claim 1, wherein the drying in step (c) is performed at a temperature in the range of from 80 to 120° C.

6. The process according to claim 1, wherein the water-soluble salts of manganese and nickel in step (a) are the sulfates.

7. The process according to claim 1, wherein in certain intervals, the nozzle is flushed with water to physically remove transition metal (oxy)hydroxide incrustations.

8. The process according to claim 1, wherein TM contains metals according to formula (I) 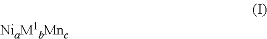
where the variables are each defined as follows:
M¹ is at least one metal selected from the group consisting of Co, Ti, Zr, Nb, Ta, W, Sb, Sr, Al and Mg,
a is a number in the range from 0.20 to 0.50,
b is a number in the range from zero to 0.05,
c is a number in the range from 0.50 to 0.80,
and a+b+c=1.0.

9. A particulate metal (oxy)hydroxide according to general formula (II) 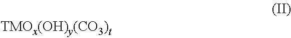
wherein TM refers to a combination of metals of which at least 97 mol-% are transition metals and wherein TM comprises manganese and nickel, and wherein at least 50 mol-% of TM are manganese,
$$0 \leq x < 1 , 1 < y \leq 2 , and 0 \leq t \leq 0.1 ,$$
wherein said particulate transition metal (oxy)hydroxide has an average secondary particle diameter D50 in the range of from 2 to 15 μm,
and wherein such secondary particles are agglomerated from primary particles that are essentially radially oriented, and wherein
said metal (oxy)hydroxide displays reflections at 8.6 to 9.0 (a), 16.00 to 18.00 (b) and 21.40 to 22.00° 2θ (c) in X-ray diffraction analyses recorded with Cu-Kα-radiation.

10. The particulate metal (oxy)hydroxide according to claim 9, wherein TM corresponds to metals according to NiₐM¹_{b} Mn_{c} wherein
M¹ is at least one metal selected from the group consisting of Co, Ti, Zr, Nb, Ta, W, Sb, Sr, Al and Mg,
a is a number in the range from 0.20 to 0.50,
b is a number in the range from zero to 0.05,
c is a number in the range from 0.50 to 0.80,
and a+b+c=1.0.

11. The particulate metal (oxy)hydroxide according to claim 9, having a specific surface according to BET in the range of from 2 to 50 m²/g.

12. The particulate metal (oxy)hydroxide according to claim 9, wherein the particle size distribution [(D90)−(D10)] divided by (D50) is in the range of from 0.5 to 2.

13. The particulate metal (oxy)hydroxide according to claim 9, wherein the average form factor of secondary particles that is higher than 0.80 when determined by SEM imaging in 1000× magnification.

14. A method of using the particulate metal (oxy)hydroxides according to claim 9, the method comprising using the particulate metal (oxy)hydroxides for the manufacture of cathode active materials for lithium-ion batteries.

15. A process for making a cathode active material for a lithium-ion battery wherein said process includes the steps of
(1) mixing at least one metal (oxy)hydroxide according to claim 9, with at least one compound of lithium selected from the group consisting of lithium hydroxide, lithium carbonate and lithium peroxide and, optionally, at least one oxide or (oxy)hydroxide or sulfate of Mg, Al, Ti, Zr, Nb, Ta, W or Mo, and
(2) heating the mixture obtained from step (1) to 800 to 1000° C.

16. A particulate cathode active material according to the general formula Li₁₊ₖTM₁₋ₖO₂ wherein k is in the range of from 0.1 to 0.3, and wherein TM refers to a combination of metals of which at least 97 mol-% are transition metals and wherein TM comprises manganese and nickel, and wherein at least 50 mol-% of TM are manganese,
wherein said particulate cathode active material has an average secondary particle diameter D50 in the range of from 2 to 15 μm,
and wherein such secondary particles are agglomerated from primary particles that are essentially radially oriented, and wherein such secondary particles have an average form factor that is higher than 0.80 when determined by SEM imaging in 1000× magnification.

17. (canceled)
